(19) United States
(12) Patent Application Publication
(10) Pub. No.: US 2025/0110216 A1
(43) Pub. Date: Apr. 3, 2025

(54) METHOD, DEVICE, AND COMPUTER-READABLE STORAGE MEDIUM FOR EMITTING LASER SIGNALS

(71) Applicant: SUTENG INNOVATION TECHNOLOGY CO., LTD., Shenzhen (CN)

(72) Inventors: Changsheng GONG, Shenzhen (CN); Rentian CAO, Shenzhen (CN)

(73) Assignee: SUTENG INNOVATION TECHNOLOGY CO., LTD., Shenzhen (CN)

(21) Appl. No.: 18/795,133

(22) Filed: Aug. 5, 2024

(30) Foreign Application Priority Data
Sep. 28, 2023 (CN) 202311287208.1

(51) Int. Cl. G01S 7/484; G01S 17/10

(52) U.S. Cl. CPC G01S 7/484; G01S 17/10

(57) ABSTRACT

This application provides a method, device, and computer-readable storage medium for emitting laser signals. The method includes: setting the emission power of the emitting unit based on the measurement range of the LiDAR's emitting unit and/or the strength of the obtained echo signal corresponding to the emitting unit, where the emitting unit has at least two levels of emission power corresponding to different measurement ranges, and each level corresponds to a specific strength of emission power; emitting a laser signal via the emitting unit based on the emission power, where the laser signal is used for measuring the target detection object.

### CROSS-REFERENCE TO RELATED APPLICATION

The present application claims the benefit of priority to Chinese Patent Application No. 202311287208.1, filed on Sep. 28, 2023, which is hereby incorporated by reference in its entirety.

### TECHNICAL FIELD

The present application relates to the field of LiDAR technology, and particularly relates to a method, device, and computer-readable storage medium for emitting laser signals.

### TECHNICAL BACKGROUND

LiDAR is a radar system that emits laser signals to detect characteristics such as the position and speed of objects within a target scene. The working principle involves emitting a laser signal to a target detection object within a target scene and then comparing the received echo signal reflected back from the target detection object with the emitted laser signal. After appropriate processing, relevant information about the target detection object, such as distance, orientation, height, speed, posture, and even shape parameters between the LiDAR and the target detection object, can be obtained, enabling detection, tracking, and identification of objects within the target scene.

However, the waveform of the echo signal may be influenced by many factors, and either over-saturation of the echo signal or too weak a waveform can lead to inaccurate measurement results.

### SUMMARY

Embodiments of this application provide a parameter configuration method, device, and computer-readable storage medium to improve radar detection accuracy.

In a first aspect, an embodiment provides a parameter configuration method, including:
setting an emission power of a LiDAR based on the measurement range of the emitting unit and/or the strength of the obtained echo signal corresponding to the emitting unit, where the LiDAR has at least two levels of emission power corresponding to different measurement ranges, and each level corresponds to a kind of emission power strength;
emitting a laser signal via the emitting unit based on the emission power, where the laser signal is used for measuring the target detection object.

In an embodiment, the method further includes:
setting an emission order of laser signals corresponding to different emission powers based on detection requirements;
emitting a laser signal via the emitting unit based on the emission power includes:
emitting the laser signals corresponding to different emission powers via the emitting unit according to the emission order.

In an embodiment, the emission order includes:
emitting a plurality of laser signals corresponding to a first level of emission power before emitting a plurality of laser signals corresponding to a second level of emission power, where the emission power of the second level is greater than the emission power of the first level; or
emitting the laser signals corresponding to the emission powers of the first level and the laser signals corresponding to the emission powers of the second level.

In an embodiment, the method further includes:
performing digital signal processing on the echo signals corresponding to each level of laser signals to obtain a plurality of first processing data, where the first processing data correspond to the levels one by one;
performing digital signal processing on the echo signals corresponding to all levels of laser signals to obtain second processing data;
performing calculation on the first processing data and the second processing data respectively, and performing data fusion on the calculation results to obtain measurement results.

In an embodiment, the method further includes:
setting a plurality of processing windows based on detection requirements, where each processing window includes at least one echo signal corresponding to a laser signal;
performing digital signal processing on the echo signals corresponding to the laser signals in each window, to obtain a plurality of first processing data, where the first processing data correspond to the processing windows one by one;
performing digital signal processing on the echo signals corresponding to all windows to obtain second processing data;
performing calculation on the first processing data and the second processing data respectively, and performing data fusion on the calculation results to obtain measurement results.

In an embodiment, the method further includes:
determining whether the confidence level of the echo signals corresponding to the laser signals in a first window of the plurality of processing windows meets the preset requirements;
if the confidence level of the echo signals meets the preset requirements, canceling the emission of laser signals after the first window in the emission cycle in which the first window is located.

In an embodiment, determining whether the confidence level of the echo signals corresponding to the laser signals in the first window of the plurality of processing windows meets the preset requirements includes:
determining whether the confidence level of the echo signals meets the preset requirements based on the parameters of the echo signals, where the parameters include one or more of the pulse width, amplitude, area, rising edge slope, and falling edge slope of the echo signals.

In an embodiment, the method further includes: setting levels of the emission power based on detection requirements.

In a second aspect, an embodiment provides a parameter configuration device, including:
a setting module, configured to set the emission power of the LiDAR based on the reflectivity of target detection objects located in different measurement ranges, where the LiDAR has at least two levels of emission power corresponding to different measurement ranges, and each level corresponds to a kind of emission power strength;
an emitting module, configured to emit laser signals based on the emission power, where the laser signals are used for measuring the target detection object.

In a third aspect, an embodiment provides a laser signal emitting device, including: a processor and a storage; where the storage stores a computer program, and the computer program is configured to be loaded and executed by the processor to perform the steps of the method embodiments.

In a fourth aspect, an embodiment provides a computer-readable storage medium, where the computer-readable storage medium stores a computer program, and when executed by a processor, the computer program implements the steps of the method embodiments.

The method provided in the embodiments of this application can set the emission power of the emitting unit based on the measurement range of the emitting unit or the obtained echo signals corresponding to the emitting unit, ensuring that the amplitude of the echo signals reflected from different target detection objects is within a suitable range. This avoids the situation where the echo signals corresponding to target detection objects located at closer ranges or with higher reflectivity are over-saturated, leading to inaccurate measurement data, thus improving the measurement range and accuracy of the LiDAR. In some embodiments, the method can set the emission power of the emitting unit based on the measurement range of the emitting unit and the obtained echo signals corresponding to the emitting unit. For example, the emission power can be set based on the measurement range of the emitting unit, and then the echo signals can be obtained, and the emission power can be adjusted based on the strength of the echo signals, improving measurement accuracy.

In an embodiment, the echo signals can be processed by summing them up based on the levels of emission power. Since the power of the laser signals for the same level is the same, the echo signals corresponding to the laser signals for the same level are relatively stable (the amplitude of the echo signals is concentrated within a relatively small range). Therefore, summing up calculations for the echo signals by each level can help improve measurement accuracy. In some embodiments, processing windows can be set based on detection requirements, and the echo signals can be summed up based on the processing windows. Since each processing window is set based on detection requirements, the laser signals within each window may have the same or similar characteristics. Therefore, summing up calculations for the echo signals by each window can more effectively improve measurement accuracy, avoiding interference from sunlight or other noise.

### BRIEF DESCRIPTION OF DRAWINGS

To make the technical solutions in the embodiments of this application clearer, the following brief introduction to the accompanying drawings required for the embodiments will be provided.

FIG. 1 shows an exemplary application scenario of the laser signal emitting method in accordance with some embodiments of this application;

FIG. 2 shows an exemplary waveform of the echo signal in a practical application scenario in accordance with some embodiments of this application;

FIG. 3 shows another exemplary waveform of the echo signal in a practical application scenario in accordance with some embodiments of this application;

FIG. 4 shows yet another exemplary waveform of the echo signal in a practical application scenario in accordance with some embodiments of this application;

FIG. 5 is a schematic flowchart of the laser signal emitting method in accordance with some embodiments of this application;

FIG. 6 is a control diagram of the laser signal emission timing in accordance with some embodiments of this application;

FIG. 7 is another control diagram of the laser signal emission timing in accordance with some embodiments of this application;

FIG. 8 is a system architecture diagram in accordance with some embodiments of this application;

FIG. 9 is yet another control diagram of the laser signal emission timing in accordance with some embodiments of this application;

FIG. 10 is yet another control diagram of the laser signal emission timing in accordance with some embodiments of this application;

FIG. 11 is another system architecture diagram in accordance with some embodiments of this application;

FIG. 12 is yet another control diagram of the laser signal emission timing in accordance with some embodiments of this application;

FIG. 13 is yet another system architecture diagram in accordance with some embodiments of this application;

FIG. 14 is a structural schematic diagram of the laser signal emitting device in accordance with some embodiments of this application; and

FIG. 15 is another structural schematic diagram of the laser signal emitting device in accordance with some embodiments of this application.

### DETAILED DESCRIPTION

To make the objectives, technical solutions, and advantages of the embodiments of this application clearer, the following description will be provided in conjunction with the accompanying drawings of the embodiments of this application. Clearly, the described embodiments are only part of the embodiments of this application and not all of them.

The terms “first,” “second,” “third,” “fourth,” and various other numeral terms in the description and claims of this application and the accompanying drawings (if any) are used to distinguish similar objects and not necessarily to describe a specific order or sequence. These terms can be interchanged under appropriate circumstances to allow the embodiments described herein to be implemented in sequences other than those illustrated or described. Additionally, the terms “comprises” and “includes,” and any of their variations, are intended to cover non-exclusive inclusions. For example, a process, method, system, product, or apparatus that includes a list of steps or elements is not limited to only those steps or elements but may include other steps or elements not expressly listed or inherent to such a process, method, system, product, or apparatus.

Unless otherwise specified, the term “/” means “or,” for example, A/B may mean A or B. The term “and/or” in this document is simply an associative relationship between associated objects and means that there may be three kinds of relationships. For example, A and/or B can mean that A exists alone, A and B exist together, or B exists alone. Unless otherwise specified, the terms “plurality” or “multiple” mean two or more.

The operation methods in the method embodiments of this application can also be applied to the device embodiments or system embodiments.

In embodiments of this application, absent special instructions and logical conflicts, the terms and/or descriptions in different embodiments are consistent and can be referenced to each other. The technical features in different embodiments can be combined to form new embodiments based on their intrinsic logical relationships.

Various numerical identifiers in this application are only for convenience of description and differentiation. The size of the serial numbers of the above processes does not imply the order of execution, and the order of execution of the processes should be determined by their functions and intrinsic logic.

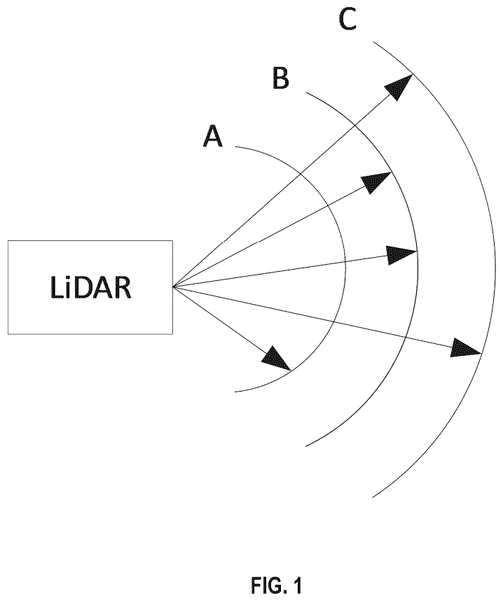

A LIDAR usually includes a laser, a receiver, and a control system. The laser converts electrical pulses into optical pulses and emits them as laser signals, while the receiver converts the optical pulses reflected from the target, the echo signals, back into electrical pulses and sends them to the control system. The LiDAR can obtain relevant information about various objects in the target scene by comparing the received echo signals reflected from the target detection object within the target scene with the emitted laser signals and appropriately processing them. However, the waveform of the echo signals can be influenced by many factors, leading to the inability to obtain measurement results or the measurement results being inaccurate. For example, the waveforms of the echo signals reflected from target detection objects at different positions may vary. Some echo signals may be over-saturated, while the amplitude of other echo signals may not meet the measurement requirements, all of which can affect the final measurement results. The following will be an exemplary illustration of a practical scenario with reference to FIGS. 1 to 4.

FIG. 1 shows an application scenario of the laser signal emitting method provided in an embodiment. The application scenario shown in FIG. 1 can include: LiDAR, detection range A, detection range B, and detection range C in the target scene. The detection distances in detection ranges A, B, and C increase sequentially. The reflectivity of objects in different detection ranges may vary, resulting in different intensities of the echo signals.

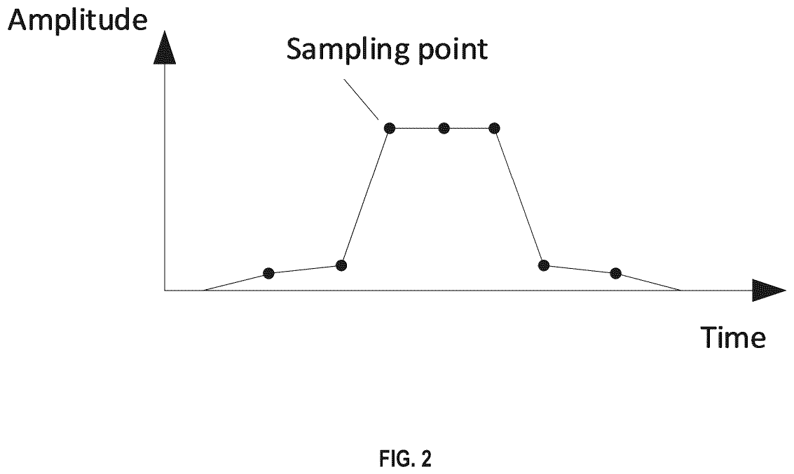

For example, FIG. 2 shows an exemplary waveform of an echo signal reflected from a target detection object in detection range A. As can be seen from FIG. 2, due to the close distance of detection range A, the reflectivity of the target detection object is relatively high, and the echo signal may be over-saturated, with a sudden change in the rising edge. In this case, it is impossible to accurately calculate the timing of the echo, there is no suitable edge for distance measurement detection.

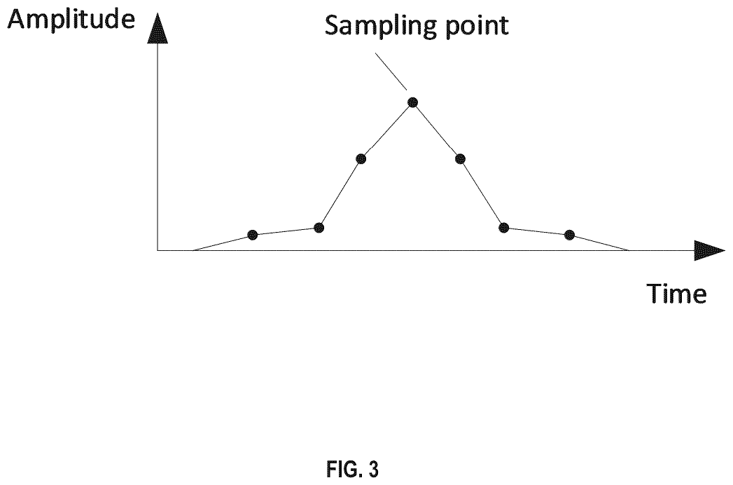

Similarly, FIG. 3 shows an exemplary waveform of an echo signal reflected from a target detection object in detection range B. As can be seen from FIG. 3, since the distance of detection range B is moderate, the echo signal is not saturated. In this case, using CFD, half-value calculation method, centroid calculation method, and other methods can accurately calculate the timing of the echo signal.

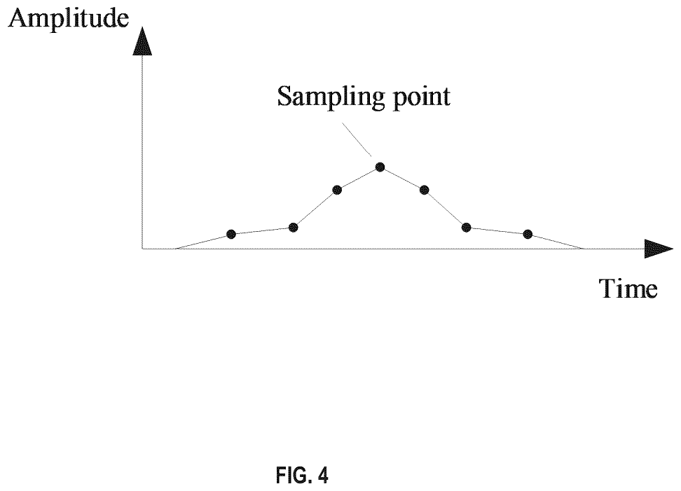

Similarly, FIG. 4 shows an exemplary waveform of an echo signal reflected from a target detection object in detection range C. As can be seen from FIG. 4, due to the far distance of detection range C, the reflectivity of the target detection object is relatively low, and the waveform of the echo signal is weak. Its signal amplitude may not reach the detection threshold, making it difficult to effectively identify the echo signal.

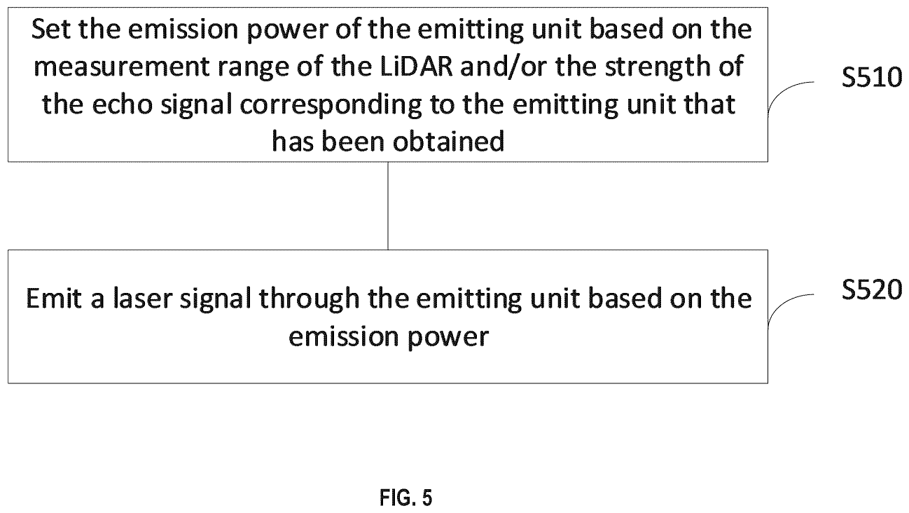

Embodiments of this application provide a laser signal emitting method, in which the emission power of the laser signal can be controlled based on the detection distance range and/or the reflectivity of the target detection object detected in the echo signal, ensuring that the echo signals reflected from the target detection objects in different detection distance ranges and/or different reflectivity are within a suitable detection range. The following is an exemplary illustration of the laser signal emitting method provided in the embodiments with reference to FIG. 5:

S510. Set the emission power of the emitting unit based on the measurement range of the LiDAR and/or the strength of the echo signal corresponding to the emitting unit that has been obtained.

Exemplarily, before the LiDAR emits a laser signal through the emitting unit, the emission power can be preset. For example, the emission power of the emitting unit can be set based on the measurement range of the emitting unit and/or the strength of the echo signal corresponding to the emitting unit that has been obtained.

In one example, the LiDAR includes an emitting array, and the emission power of one or a group of emitting units in the emitting array can be set according to the above scheme.

The emitting array can include one or multiple groups of emitting units, where each group of emitting units can include one or multiple emitting units. The number of emitting units in each group can be the same or different. The emission timing of different groups of emitting units can be the same or different.

Below is an exemplary illustration of the specific implementation method for setting the emission power, by taking the setting of the emission power of one emitting unit as an example.

In an embodiment, the emission power of the emitting unit is set based on the measurement range of the emitting unit. Exemplarily, the measurement ranges of different emitting units may vary. If the measurement range of an emitting unit is relatively large, a relatively large emission power can be set to measure target detection objects within a longer range. If the measurement range of an emitting unit is relatively small, a relatively small emission power can be set to prevent the received echo signal from being over-saturated.

In an embodiment, the emission power of the emitting unit is set based on the strength of the echo signal corresponding to the emitting unit that has been obtained. Exemplarily, the strength of the echo signal can reflect the reflectivity of the target detection object, where the target detection object refers to the object to be measured within the measurement range of the LiDAR, and the reflectivity of the target detection object refers to the ratio of the energy amplitude of the echo signal reflected by the target detection object to the energy amplitude of the emitted signal corresponding to the echo signal. The obtained echo signal can refer to one or more scan frames of echo signals obtained before acquiring the current frame corresponding echo signal. In an embodiment, if the strength of the obtained echo signal is relatively high, it indicates that the reflectivity of the target detection object is relatively high. A relatively low emission power can be set to reduce the signal amplitude of the echo signal and prevent the echo signal from being over-saturated. If the strength of the obtained echo signal is relatively low, it indicates that the reflectivity of the target detection object is relatively low. At this time, a relatively high emission power can be set to increase the signal amplitude of the echo signal and prevent the echo signal from failing to reach the measurement threshold. Based on the above, the emission power of the emitting unit can be set based on the strength of the obtained echo signal, which can also be expressed as setting the emission power of the emitting unit based on the reflectivity of the target detection object.

In an embodiment, the reflectivity is inversely proportional to the measurement range. Therefore, the emission power of the LiDAR can be set based on the measurement range where the target detection object is located (or the distance between the target detection object and the LiDAR). For example, when the target detection object is in a close measurement range (such as measurement range A in FIG. 1), a relatively low emission power can be set. When the target detection object is in a far measurement range (such as measurement range C in FIG. 1), a relatively high emission power can be set.

In one implementation, the emission power of the emitting unit is set based on the measurement range of the emitting unit and the strength of the obtained echo signal corresponding to the emitting unit. Exemplarily, the emission power of the emitting unit can be set by comprehensively considering the measurement range of the emitting unit and the strength of the obtained echo signal. In other implementations, the emission power can be set based on the measurement range of the emitting unit, and then adjusted based on the strength of the obtained echo signal after emitting the laser signal with the set emission power and obtaining the corresponding echo signal.

The method provided in the embodiments of this application allows for different emission powers of the laser signals used to measure different target detection objects. In one exemplary implementation, the emission power levels can be set based on detection requirements. Each level corresponds to a specific intensity (or energy amplitude) of emission power. The LiDAR has at least two levels of emission power corresponding to different measurement ranges.

For example, two levels of emission power can be set based on detection requirements, referred to as the first level and the second level, where the emission power of the first level is less than that of the second level. In the first measurement range, the LiDAR can emit laser signals with the first level of emission power to measure target detection objects within the first measurement range. The lower emission power of the first level can reduce the energy amplitude of the echo signal, avoiding distortion of the waveform due to over-saturation of the echo signal. In the second measurement range, the LiDAR can emit laser signals with the second level of emission power to measure target detection objects within the second measurement range. The higher emission power of the second level can increase the energy amplitude of the echo signal, ensuring that the echo signal reaches the measurement threshold. Thus, the above scheme can extend the measurement range of the LiDAR.

According to detection requirements (e.g., actual data acquisition requirements), three or more levels of emission power can be set. Setting more levels of emission power is conducive to improving the measurement accuracy of the LiDAR and the accuracy of reflectivity. For convenience, the following explanation will be based on two levels of emission power.

S520. Emit a laser signal through the emitting unit based on the emission power.

Exemplarily, after setting the emission power of the LiDAR based on the reflectivity of the target detection object, the laser signal can be emitted through the emitting unit according to the set emission power to measure target detection objects within different measurement ranges.

In an embodiment, the emission order of laser signals corresponding to different emission powers can be set based on detection requirements. The emission timing of laser signals corresponding to different emission powers can be controlled based on detection requirements, and then laser signals can be emitted according to the emission order.

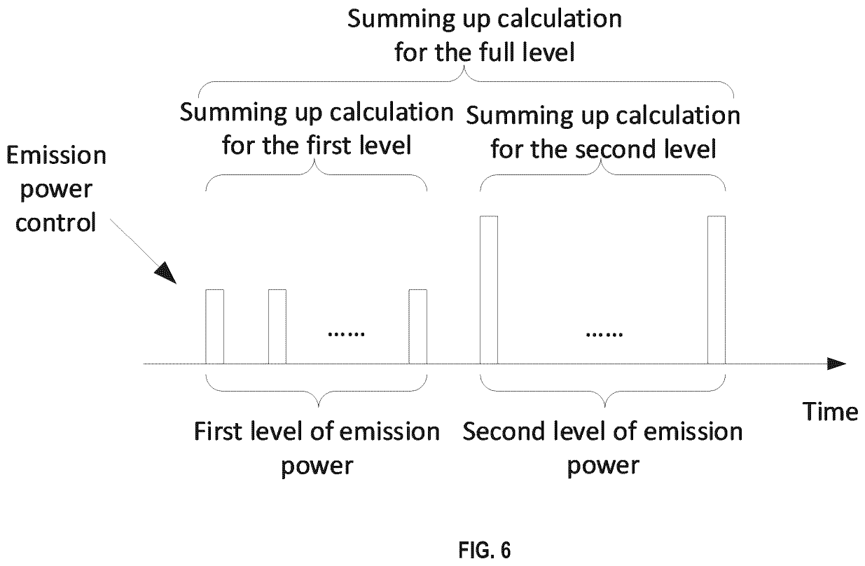

In an example, for an emitting unit in the emitting array or a group of emitting units in the emitting array, laser signals corresponding to the first level of emission power can be emitted first, followed by laser signals corresponding to the second level of emission power. In other words, low-power laser signals can be emitted first. After the low-power laser signals are emitted, high-power laser signals can be emitted. FIG. 6 shows an application scenario of this example.

The emitting array can include one or multiple groups of emitting units, where each group of emitting units can include one or multiple emitting units. The number of emitting units in each group can be the same or different. The emission timing of different groups of emitting units can be the same or different.

FIG. 6 shows a control diagram of the emission timing of laser signals corresponding to a group of emitting units in one emission cycle. The histogram in the figure represents laser signals, and the height of the histogram represents the power of the laser signals. In this example, two levels of emission power are set based on detection requirements, namely the first level of emission power and the second level of emission power, with the second level of emission power being greater than the first level of emission power. The LiDAR first emits laser signals corresponding to the first level of emission power, followed by laser signals corresponding to the second level of emission power.

The number of emissions for each level is related to detection requirements. The higher the detection accuracy required for the detection range, the more emissions for that level. The number of emissions for the same level of emission power for the same group of emitting units can be the same. The emission levels and the number of emissions for each level of different groups of emitting units can be different.

In one exemplary implementation, the scheme shown in FIG. 6 can be applied to a scenario where the position of the LiDAR is fixed.

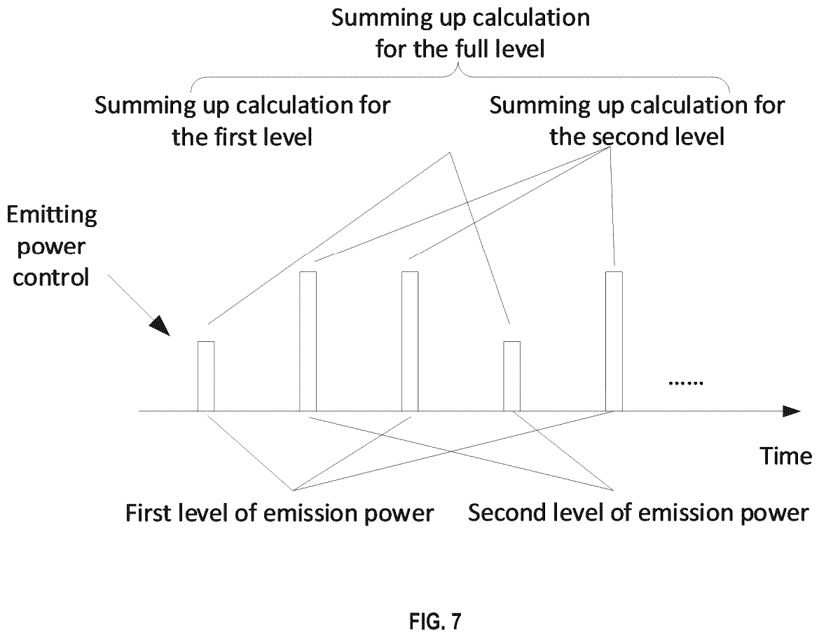

In an example, laser signals corresponding to the first level of emission power and the second level of emission power can be emitted. One or more laser signals with the first level of emission power can be emitted first, followed by one or more laser signals with the second level of emission power, and then one or more laser signals with the first level of emission power, and so on. FIG. 7 shows an application scenario of this example.

FIG. 7 shows a control diagram of the emission timing of laser signals in one emission cycle. In this example, two levels of emission power are set based on detection requirements, namely the first level of emission power and the second level of emission power. The LiDAR first emits one laser signal with the first level of emission power, then emits two laser signals with the second level of emission power, then emits one laser signal with the first level of emission power, and then emits two laser signals with the second level of emission power. The emission timing shown in FIG. 7 is one example. In practical applications, other emission timings can be used to emit laser signals with different levels of emission power.

In one exemplary implementation, the scheme shown in FIG. 7 can be applied to a scenario where the position of the LiDAR is moving.

In an embodiment, after emitting laser signals according to the above scheme, the echo signals corresponding to each laser signal can be received, and then these echo signals can be processed to obtain measurement results.

In an exemplary implementation (referred to as scheme one), echo signals corresponding to each level of laser signal (the emission power level of the laser signal) can be processed separately by summing them up.

For example, digital signal processing can be performed separately on the echo signals corresponding to each level of laser signal, obtaining multiple first processing data, where the first processing data correspond to the levels one by one. Digital signal processing can be performed on the echo signals corresponding to all levels of laser signals, obtaining second processing data. The first processing data and the second processing data can be solved separately, and the calculation results can be fused to obtain measurement results.

Scheme one can be applied to the scheme shown in FIG. 6: summing up calculations can be performed separately for the first level, the second level, and the full levels. Summing up calculations for the first level refers to performing digital signal processing on the echo signals corresponding to the laser signals with the first level of emission power, summing up calculations for the second level refers to performing digital signal processing on the echo signals corresponding to the laser signals with the second level of emission power, and summing up calculations for the full levels refers to performing digital signal processing on the echo signals corresponding to all laser signals. Furthermore, distance and/or reflectivity calculations can be performed based on the calculation results, and all data can be fused to obtain the measurement results.

Since the power of the laser signals for the same level is the same, the echo signals corresponding to the laser signals for the same level are relatively stable (the amplitudes of the echo signals are concentrated within a relatively small range). Therefore, summing up calculations for the echo signals by each level can help improve measurement accuracy.

Similarly, scheme one can also be applied to the scheme shown in FIG. 7.

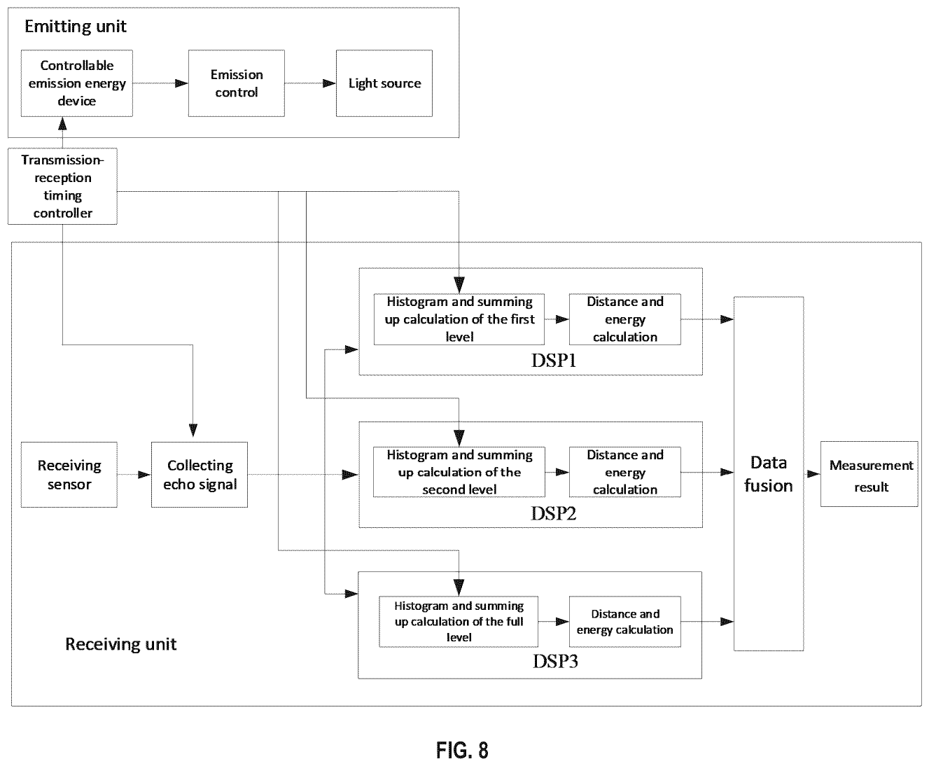

FIG. 8 shows a system architecture diagram for implementing scheme one. As shown in FIG. 8, the system architecture includes an emitting unit, a receiving unit, and a transmission-reception timing controller. The emitting unit is used to emit laser signals, the receiving unit is used to receive echo signals, and the transmission-reception timing controller is used to control the emission timing of laser signals with different levels of emission power.

The emitting unit includes a controllable emission energy device. The controllable emission energy device is used to set the emission power of the LiDAR and control the emission. The controllable emission energy device controls the emitter to emit laser signals with different levels of emission power based on the emission timing configured by the transmission-reception timing controller.

The receiving unit includes a receiving sensor. The receiving sensor is used to collect echo signals. Based on the transmission-reception timing information generated by the transmission-reception timing controller, the collected echo signals can be grouped according to the emission power levels. Suppose the emission power includes two levels: the first level and the second level. The histogram of the first level (the echo signals corresponding to the laser signals with the first level of emission power) is regarded as the first group, and summing up calculations are performed by DSP1 for the first level. Distance and reflectivity calculations are then performed based on the calculation results. The histogram of the second level (the echo signals corresponding to the laser signals with the second level of emission power) is regarded as the second group, and summing up calculations are performed by DSP2 for the second level. Distance and energy calculations are then performed based on the calculation results. The full-level histogram (the echo signals corresponding to the laser signals of all levels) is regarded as the third group, and summing up calculations are performed by DSP3 for the full level. Distance and energy calculations are then performed based on the calculation results. Data fusion of the calculation results of the above three groups of signals can yield the final measurement results.

In an exemplary implementation (referred to as scheme two), multiple processing windows can be set based on detection requirements, where each processing window includes at least one laser signal. The echo signals corresponding to the laser signals in each processing window are regarded as a group of signals. These signals can then be processed separately based on each group. For example, digital signal processing can be performed separately on the echo signals corresponding to the laser signals in each processing window, obtaining multiple first processing data, where the first processing data correspond to the processing windows one by one. Digital signal processing can be performed on the echo signals corresponding to all windows, obtaining second processing data. The first processing data and the second processing data can be solved separately, and the calculation results can be fused to obtain measurement results.

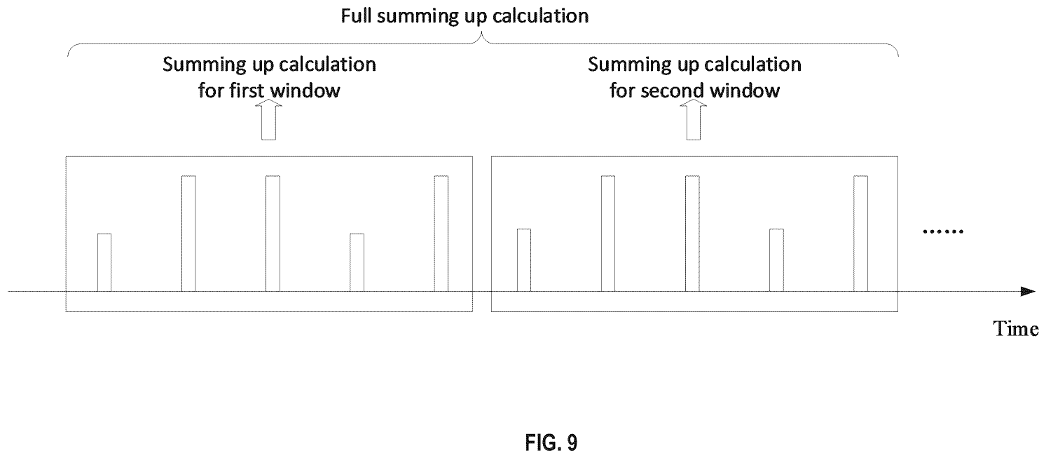

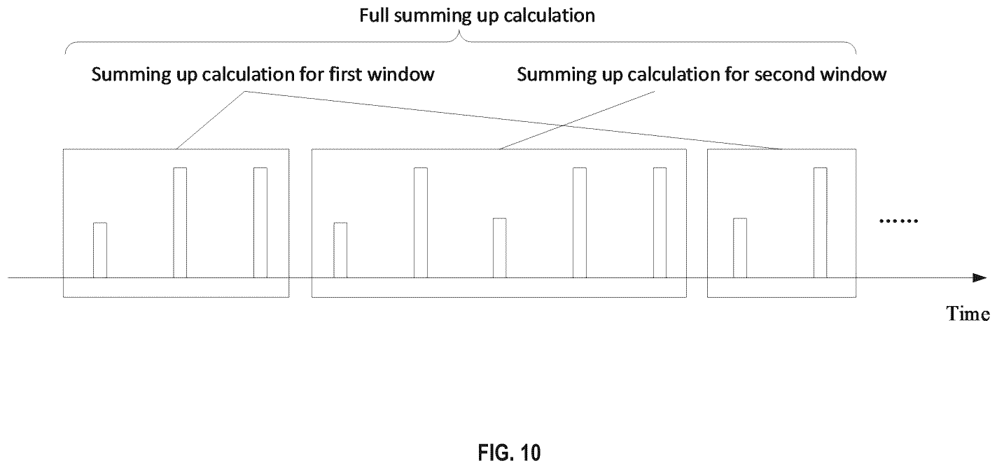

The following explanations will be based on FIGS. 9 and 10, which introduce two processing window settings. FIGS. 9 and 10 are based on the example shown in FIG. 7. The schemes in FIGS. 9 and 10 can also be applied to the example in FIG. 6.

FIG. 9 introduces the first processing window setting method. In the scheme shown in FIG. 9, adjacent laser signals are divided into one processing window. For example, the signals of one emission cycle are divided into two processing windows: the first window and the second window. The first window includes the first to the fifth laser signals (the first to the fifth histograms), and the second window includes the sixth to the tenth laser signals. In this case, summing up calculations can be performed separately for the echo signals corresponding to the first window and the second window, as well as full summing up calculations for the echo signals corresponding to all windows. Finally, data calculation and data fusion can yield the measurement results.

FIG. 10 introduces the second processing window setting method. In the scheme shown in FIG. 10, different time segments of laser signals can be divided into one processing window based on actual measurement needs. Non-adjacent laser signals can be divided into one processing window. For example, the signals of one emission cycle are divided into two processing windows: the first window and the second window. The first window includes the first to the third laser signals and the ninth to the tenth laser signals, and the second window includes the fourth to the eighth laser signals. In this case, summing up calculations can be performed separately for the echo signals corresponding to the first window and the second window, as well as full summing up calculations for the echo signals corresponding to all windows. Finally, data calculation and data fusion can yield the measurement results.

Since each processing window is set based on detection needs, the laser signals within each window may correspond to the same or similar needs and thus have the same or similar characteristics. Therefore, summing up calculations for the echo signals by each window can effectively improve measurement accuracy and avoid interference from sunlight or other noise.

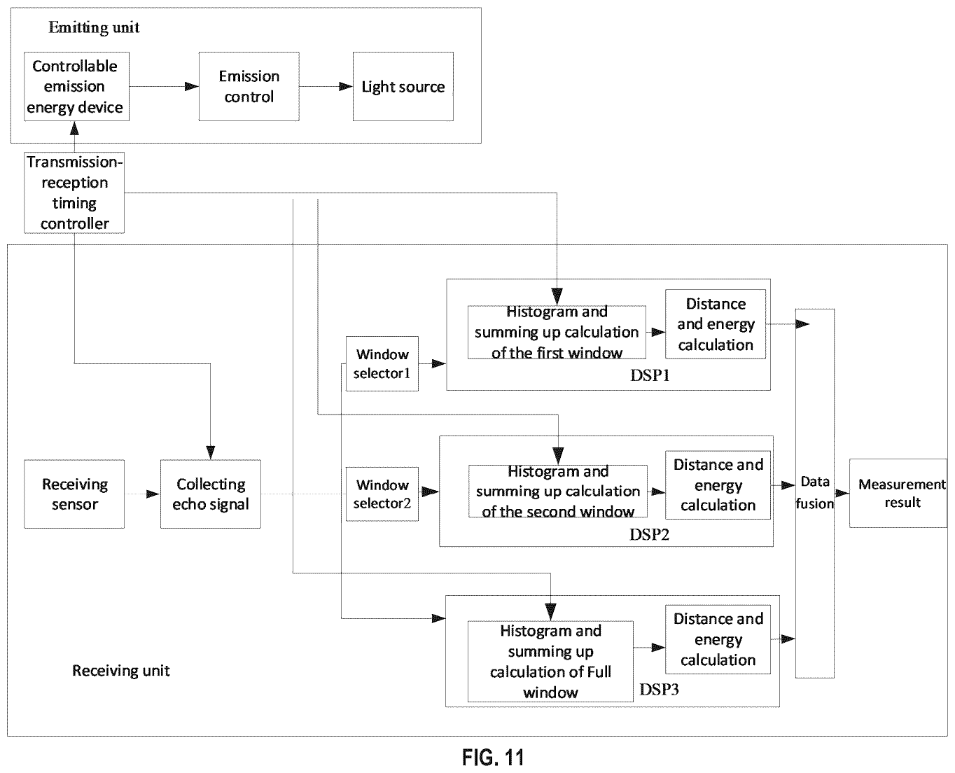

FIG. 11 shows a system architecture diagram for implementing scheme two. The system shown in FIG. 11 is similar to the system shown in FIG. 8, and the similar units or processing flows will not be repeated. Compared with the system shown in FIG. 8, the system in FIG. 11 includes multiple window selectors. These window selectors are connected to the receiving sensor. After the receiving sensor completes the collection of echo signals, the window selectors can set the processing windows based on the preset scheme (such as the scheme corresponding to FIG. 9 or FIG. 10). According to the processing windows, the signals within each processing window can be processed separately. Window selector 1 and window selector 2 in FIG. 11 can be two different window selectors or the same window selector.

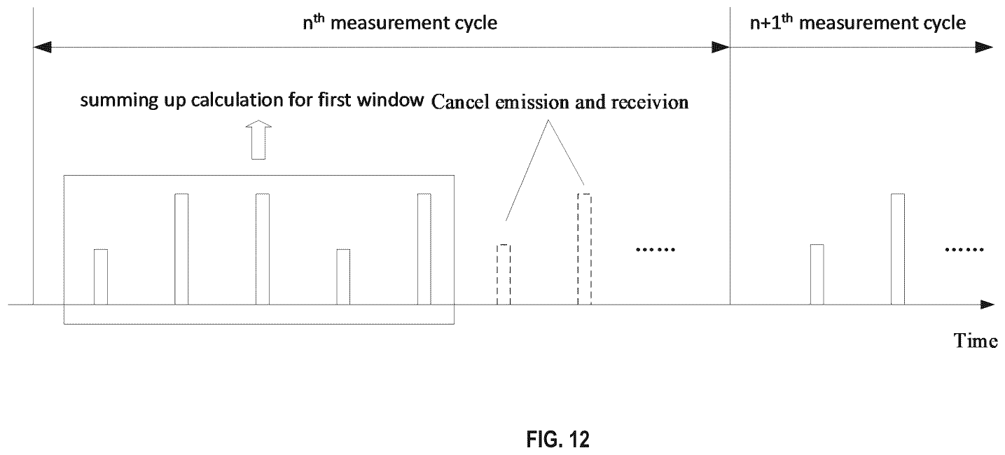

In an embodiment, based on the above scheme two, the confidence level of the echo signals within each processing window can be determined to meet the requirements. If the requirements are met, the emission of signals after the current processing window in the emission cycle can be canceled. The following explanations will be based on FIG. 12 to illustrate this implementation method. In FIG. 12, taking the nth measurement cycle as an example, the measurement cycle includes multiple processing windows, with the first window being one of these processing windows. During the processing of the echo signals corresponding to the first window (or before processing starts or after processing is completed), it is determined whether the confidence level of the echo signals within the first window meets the preset requirements. If the confidence level of the echo signals within the first window meets the preset requirements, the emission of laser signals after the first window within the emission cycle where the first window is located can be canceled. This method can save time, improve frame rate, and reduce the power consumption of the entire system.

In an embodiment, if the confidence level of the echo signals within the first window meets the preset requirements, the full window summing up calculations can be canceled to save time and reduce power consumption.

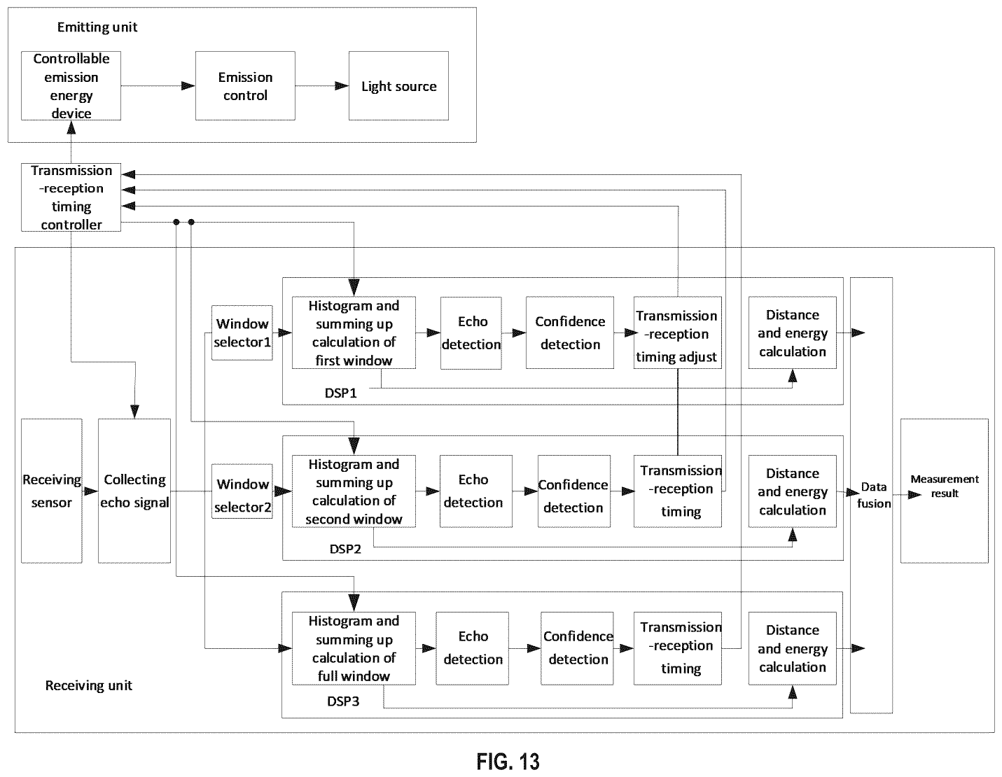

FIG. 13 shows a system architecture diagram for implementing the above confidence level determination process. The system shown in FIG. 13 is similar to the system shown in FIG. 9, and the similar units or processing flows will not be repeated. Compared with the system shown in FIG. 11, the system in FIG. 13 adds confidence detection and transmission-reception timing adjustment processes. Taking the signal processing flow of the first window as an example: after summing up the echo signals corresponding to the first window, echo detection and confidence detection are performed sequentially. If the confidence detection passes, there are echo signals meeting the confidence level requirements within the first window, the transmission-reception timing can be adjusted. A control signal can be sent to the transmission-reception timing controller to indicate that the transmission-reception timing controller should cancel the emission of signals within the processing window located after the first window in the current emission cycle. The data processing flow within other windows is similar and will not be repeated here.

In one exemplary implementation, the confidence level of the echo signals can be determined based on the parameters of the echo signals. These parameters include one or more of the following: the pulse width, amplitude, area, rising edge slope, and falling edge slope of the echo signals.

Corresponding to the methods provided in the above method embodiments, this application also provides corresponding devices. These devices include modules for implementing the corresponding methods in each of the above method embodiments. These modules can be software, hardware, or a combination of software and hardware. The technical features described in the above method embodiments also apply to the following device embodiments. Therefore, the detailed descriptions can refer to the method embodiments described above, and for simplicity, they will not be repeated here.

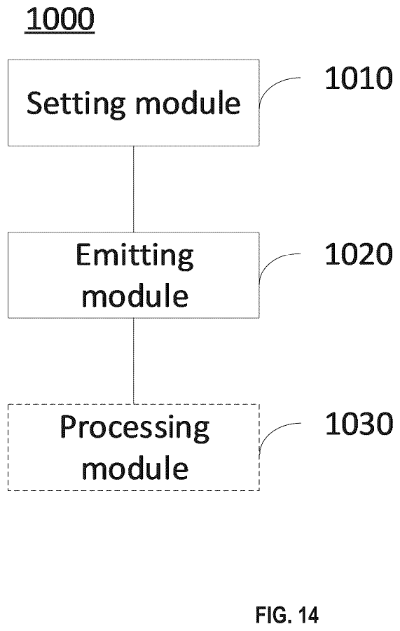

FIG. 14 shows a structural block diagram of the device 1000 provided in an embodiment. For convenience of explanation, only parts related to the embodiments of this application are shown. Referring to FIG. 14, the device can include the following modules:
setting module 1010, used to set the emission power of the emitting unit based on the measurement range of the LiDAR and/or the strength of the echo signal corresponding to the emitting unit that has been obtained. The emission power levels of the emitting unit corresponding to different measurement ranges of the LiDAR include at least two levels, and each level corresponds to a specific intensity of emission power;
emitting module 1020, used to emit laser signals based on the emission power, where the laser signals are used for measuring a target detection object.

In an embodiment, the setting module 1010 is also used to set the emission order of laser signals corresponding to different emission powers based on detection requirements. The emitting module 1020 emits laser signals corresponding to different emission powers according to the emission order.

In an embodiment, the device includes a processing module 1030, used to perform digital signal processing separately on the echo signals corresponding to each level of laser signals, obtaining multiple first processing data, where the first processing data correspond to the levels one by one. Digital signal processing is performed on the echo signals corresponding to all levels of laser signals, obtaining second processing data. The first processing data and the second processing data are solved separately, and the calculation results are fused to obtain measurement results.

In an embodiment, the setting module 1010 is used to set multiple processing windows based on detection requirements, where each processing window includes at least one laser signal. The processing module 1030 is used to perform digital signal processing separately on the echo signals corresponding to the laser signals in each processing window, obtaining multiple first processing data, where the first processing data correspond to the processing windows one by one. Digital signal processing is performed on the echo signals corresponding to all windows, obtaining second processing data. The first processing data and the second processing data are solved separately, and the calculation results are fused to obtain measurement results.

The information exchange and execution processes between the above device/unit are based on the same concept as the method embodiments of this application. The functions and technical effects brought about by these exchanges and processes can refer to the parts of the method and system embodiments described above.

For convenience and brevity of description, only the division of functional units or modules in the above examples is illustrated. In practical applications, these functions can be distributed to different functional units or modules according to needs. That is, the internal structure of the described device can be divided into different functional units or modules to complete the described functions. The functional units or modules in the examples can be integrated into one processing unit, or they can exist separately. They can also be integrated into multiple processing units. These integrated units can be implemented in the form of hardware or software functional units.

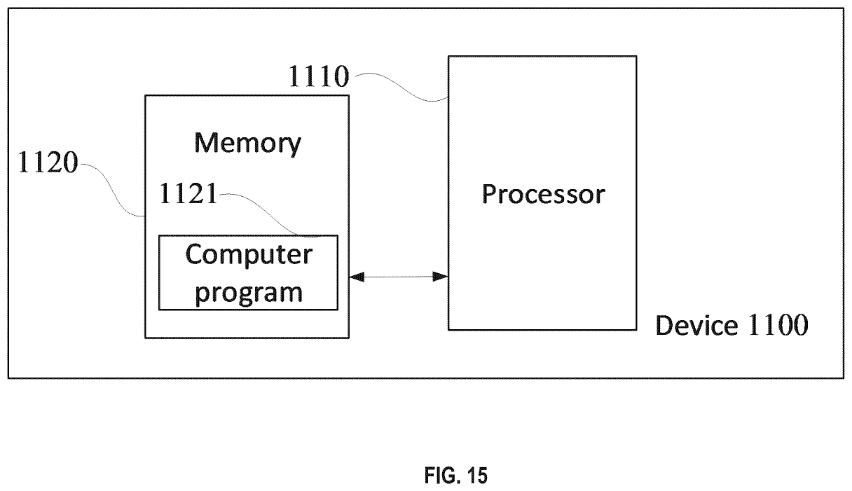

FIG. 15 shows the device 1100 provided in an embodiment, including at least one processor 1110, a memory 1120, and a computer program 1121 stored in the memory. When executed by the processor, the computer program can implement the steps of any method embodiment described above.

The embodiments of this application also provide a computer-readable storage medium. The computer-readable storage medium stores a computer program, and when executed by a processor, the program can implement the steps of any method embodiment described above.

The embodiments of this application also provide a computer program product. When the computer program product runs on electronic equipment, it enables the mobile terminal to execute the steps of any method embodiment described above.

If the integrated units are implemented as software functional units and sold or used as independent products, they can be stored in a computer-readable storage medium. Based on this understanding, all or part of the processes in the method embodiments described above can be implemented by instructing related hardware through computer programs. The computer programs can be stored in a computer-readable storage medium. When the programs are executed by a processor, the steps of the above method embodiments can be implemented. The computer programs include computer program code that can be in the form of source code, object code, executable files, or some intermediate form. The computer-readable medium can include any entity or device capable of carrying the computer program code. Examples include U disks, mobile hard disks, magnetic disks, or optical disks.

The units and algorithm steps described in the exemplary methods disclosed can be implemented in electronic hardware or a combination of computer software and electronic hardware. The choice between hardware or software implementation depends on the application and design constraints.

The disclosed device/network equipment and methods can be implemented in other forms. For example, the described functional units or modules are just examples, and the implementations can have different divisions. For instance, multiple units or components can be combined or integrated into another system, or some features can be omitted. The connections between different units or modules can be direct or indirect through interfaces or devices, and can be electrical, mechanical, or other forms.

The units described as separate components can be or can be not physically separated, and the components shown as units can be or can be not physically units, i.e., they can be located in one place or distributed across multiple network units. Some or all of the units or modules can be selected to achieve the purposes of the embodiments.

What is claimed is:

1. A method for emitting a laser signal, comprising:
setting an emission power of an emitting unit based on a measurement range of a LiDAR or a strength of an echo signal corresponding to the emitting unit that has been obtained, wherein there are at least two different levels of emission power of the emitting unit corresponding to different measurement ranges, and each level corresponds to a kind of strength of emission power; and
emitting a laser signal via the emitting unit based on the emission power, wherein the laser signal is used for measuring a target detection object.

2. The method according to claim 1, further comprising:
setting an emission order of laser signals corresponding to different emission powers based on detection requirements,
wherein emitting a laser signal via the emitting unit based on the emission power comprises:
emitting the laser signals corresponding to the different emission powers via the emitting unit according to the emission order.

3. The method according to claim 2, wherein the emission order comprises:
emitting a plurality of laser signals corresponding to different emission powers of a first level before emitting a plurality of laser signals corresponding to different emission powers of a second level, wherein the emission power of the second level is greater than the emission power of the first level; or
emitting the laser signals corresponding to the different emission powers of the first level and the laser signals corresponding to the different emission powers of the second level.

4. The method according to claim 1, further comprising:
performing digital signal processing on an echo signal corresponding to a laser signal of each level to obtain a plurality of first processing data, wherein the plurality of first processing data correspond to the levels one by one;
performing digital signal processing on echo signals corresponding to laser signals of all the levels, to obtain second processing data; and
performing calculation on the plurality of first processing data and the second processing data respectively, performing data fusion on calculation results, to obtain a measurement result.

5. The method according to claim 1, further comprising:
setting a plurality of processing windows based on detection requirements, wherein each processing window comprises at least one echo signal corresponding to a laser signal;
performing digital signal processing on an echo signal corresponding to a laser signal in each window, to obtain a plurality of first processing data, wherein the plurality of first processing data correspond to the plurality of processing windows one by one;
performing digital signal processing on echo signals corresponding to laser signals in all the windows, to obtain a second processing data; and
performing calculation on the plurality of first processing data and the second processing data respectively, performing data fusion on calculation results, to obtain a measurement result.

6. The method according to claim 4, further comprising:
determining whether a confidence level of an echo signal corresponding to a laser signal in a first window of the plurality of processing windows meets a preset requirement; and
in response to the confidence level of the echo signal meeting the preset requirement, canceling emission of a laser signal after the first window in an emission period in which the first window is located.

7. The method according to claim 6, wherein the determining whether a confidence level of an echo signal corresponding to a laser signal in a first window of the plurality of processing windows meets a preset requirement comprises:
determining whether the confidence level of the echo signal meets the preset requirement based on parameters of the echo signal, wherein the parameters comprise a pulse width, an amplitude, an area, a rising edge slope, and a falling edge slope of the echo signal.

8. The method according to claim 1, further comprising:
setting levels of the emission power based on detection requirements.

9. A laser signal emitting device, comprising:
a setting module, configured to set emission power of a LiDAR based on a measurement range of an emitting unit of the LiDAR or a strength of an echo signal corresponding to the emitting unit that has been obtained, wherein there are at least two different levels of emission power of the LiDAR corresponding to different measurement ranges, and each level corresponds to a kind of strength of emission power; and
an emitting module, configured to emit a laser signal via the emitting unit based on the emission power, wherein the laser signal is used for measuring a target detection object.

10. A non-transitory computer-readable storage medium, storing a computer program, when the computer program is executed by a processor, causes the processor to perform operations comprising:
setting an emission power of an emitting unit based on a measurement range of a LiDAR or a strength of an echo signal corresponding to the emitting unit that has been obtained, wherein there are at least two different levels of emission power of the emitting unit corresponding to different measurement ranges, and each level corresponds to a kind of strength of emission power; and
emitting a laser signal via the emitting unit based on the emission power, wherein the laser signal is used for measuring a target detection object.
